(19) United States
(12) Patent Application Publication
(10) Pub. No.: US 2014/0161582 A1
(43) Pub. Date: Jun. 12, 2014

(54) GRIPPING ELEMENT FOR MANIPULATORS

(71) Applicant: GIMATIC S.p.A., Roncadelle (BS) (IT)

(72) Inventor: Giuseppe Maffeis, Roncadelle (BS) (IT)

(73) Assignee: GIMATIC S.p.A., Roncadelle (BS) (IT)

(21) Appl. No.: 14/094,446

(22) Filed: Dec. 2, 2013

(30) Foreign Application Priority Data
Dec. 7, 2012 (IT) BS2012A000176

(51) Int. Cl. B25J 15/06

(52) U.S. Cl. CPC B25J 15/0616; B25J 15/0683
USPC 414/800; 294/189; 294/188

(57) ABSTRACT

A gripping element is provided for industrial manipulators adapted for gripping items at high temperatures, in particular composite and nylon laminates. The gripping element includes a first portion coupling to a manipulator and a second elastically deformable portion intended to interact directly with the item to be manipulated. The second portion includes a substantially flat base and a perimetrical edge which extends around the base. An air intake duct opens at the base to activate the gripping element by depression. At rest, in a first not-deformed configuration, the lying plane of the perimetrical edge and the lying plane of the base are parallel and separated. In use, in a second deformed configuration, the lying plane of the perimetrical edge and the lying plane of the base are coincident are in abutment on the caught item.

### FIELD OF THE INVENTION

The present invention claims the priority of the Italian patent application BS2012A000176, filed on Dec. 07, 2012, and refers to a gripping element for manipulators, in particular to a pneumatically—driven gripping element particularly adapted to interact with items to be manipulated at high temperatures.

### BACKGROUND

In the field of the industrial automation the use of robotized manipulators is known, a gripping element for the objects to be manipulated being normally associated with.

Mechanical gripping elements are available, for example clamps provided with movable metallic jaws which are activated electrically or by pneumatic actuators or needle clamps penetrating in part into the item to be manipulated, and pneumatic gripping elements, for example silicone suckers activated by drawing the air from their inside.

In some industrial fields there is the need of manipulating items whose surface temperature is high, above 200° C. For example in the automotive field recently the need of manipulating laminates made of composite materials rose, heated above 200° C., for their insertion into the forming or pre-forming mold. In particular the laminates made of carbon fiber and nylon fabrics are heated at a temperature of about 300° C., near to nylon fusion temperature, to make the sheets sufficiently malleable in order to be deformed in the molds and take the desired shape, without any breakage.

Traditional gripping elements proved to be inappropriate to interact with items at high temperatures and in particular with composite items impregnated with polyamide materials such as nylon. As a matter of fact these items, when heated at temperatures higher than 200° C.—in particular near to fusion or softening temperature of one of the composition materials—exhibit weakness and are probably deformable.

Needle clamps penetrate in hot items leaving holes that change the structure of the item itself. Mechanical clamps, for example of movable jaw type, warp the items to be manipulated because of related weakness.

Also silicone suckers cause undesired localized deformations of the item to be manipulated, the latter tending to rise and bend at the suckers because of the depression caused therein and weakness of the item itself at high temperatures. Moreover, in many cases it was noticed that in contact points between the sucker and the hot item, the silicone of the sucker leaves an impression over the item surface on which it is not possible to apply a possible paint layer even when time passed, when the item is cooled.

In glassmaking field, suckers coated with a particular felt made of synthetic fiber have been proposed, resisting to high temperatures, for gripping and displacing glass sheets at temperatures of about 400° C. The main drawback of this solution is that felt resists against high temperatures for a few seconds only, after that the collapse of the material and the sucker occurs.

In addition, conventional solutions suffer from the drawback of being not so much effective when the item to be manipulated is subjected to vibrations. In fact, suckers can loose the grip or not adhere to the vibrating item adequately.

### SUMMARY

The object of the present invention is to provide a gripping element, in particular of the type activated by depression, which solves simply and efficiently the drawbacks of traditional solutions, at the same time being economic and easy to be assembled on existing manipulators.

The present invention concerns therefore a gripping element according to claim 1.

In particular the present invention concerns a gripping element comprises a first portion coupling to a manipulator and a second portion, at least partially elastically deformable, intended to interact directly with the item to be manipulated. The second portion comprises in its turn a substantially flat base and a perimetrical edge which extends around said base.

At least one duct for the air intake extends in the body of the gripping element and opens in the base. The intake duct has the function of allowing to make a depression sufficient to rise and manipulate the item.

The perimetrical edge and the base lie on respective lying planes.

In a first not-deformed configuration of the second portion of the gripping element, the lying plane of the perimetrical edge and the lying plane of the base are parallel and separated, that is the lying plane of the base is over the lying plane of the perimetrical edge (with respect to the item to be manipulated) and a center-to-center is defined between them.

In a second deformed configuration of the second portion of the gripping element, the lying plane of the perimetrical edge and the lying plane of the base are coincident.

The described configuration is advantageous with respect to the known art for the following reasons.

As the second portion is subjected to an elastic deformation allowing the base and the perimetrical edge to get on the same lying plane, the gripping of an item—the latter exhibiting weakness because of high temperatures or the nature thereof—does not cause undesired deformations. When the element is gripping the item to be manipulated, the base is on the same plane of the perimetrical edge, thereby avoiding the item surface to be deformed like a dome because of the depression made in the volume defined among the base, the perimetrical edge and the item itself.

Preferably the center-to-center between the lying plane of the perimetrical edge and the lying plane of the base is comprised between 0.5 mm and 1 mm.

Preferably the gripping element is made of an antiadherent material, which does not leave any residue on manipulated items and, in its turn, does not become impregnated with residues and substances the items released, for example melted nylon, resins or thermoplastic materials quasi-liquid because of high temperatures.

The described configuration allows obviates the use of silicone in manufacturing the gripping element.

Preferably at least the second portion, and more preferably the first portion too, are made of polytetrafluoroethylene or PTFE (commonly referred to as Teflon®), or in a ceramic material, resistant against high temperatures, in particular temperatures higher than 200° C. PTFE is known to be a material having excellent antiadherent proprieties. Therefore the use of PTFE, in particular allows the gripping element not to leave any impression on items which could impede the fixing of a paint or any other coating of the manipulated item.

A further advantage is that PTFE and ceramic material do not leave residues on manipulated items, as it happens with silicone, and do not smear with the substances present on item surfaces, for example thermoplastic resins or the like.

Therefore the gripping element according to the present invention allows manipulation of hot items which exhibit weakness, without running into afore described drawbacks relating to conventional solutions.

More in detail, the not-deformed configuration corresponds to the gripping element at rest that is not constrained to the item to be manipulated.

On the contrary the deformed configuration corresponds to the gripping element in use, with the perimetrical edge and the base abutting at the same time against a surface of the item to be manipulated; the constraint between the item and the gripping element is made by creating a depression between these elements, by drawing air at the base of the gripping element.

In a first embodiment a single intake duct opens into the base centrally, and a plurality of substantially circular and concentric grooves, and fluidically connected one to the other by least one transversal groove, are obtained in the base to convey towards the intake duct the air contained in the volume defined between the base, the perimetrical edge and the surface of the item to be manipulated on which the gripping element abuts. In concrete terms the grooves make a labyrinth in the base in order to optimize the air intake in the whole area subtending the base itself.

In a second embodiment a chamber, fluidically connected to the intake duct, is defined in the body of the gripping element. Several through holes are obtained in the base in order to convey towards the chamber, and the towards the intake duct, the air contained in the volume defined between the base, the perimetrical edge and the surface of the item to be manipulated on which the gripping element abuts.

Preferably in the first embodiment the perimetrical edge is defined by a base prominence.

Preferably in the second embodiment the perimetrical edge is defined on a portion extending cantileverly from the base. In this case, the portion extending cantileverly is at least partially flexible to facilitate the deformation that moves the base into abutment against the item to be manipulated when the air is drawn through the intake duct.

Preferably the gripping element has a circular section.

Preferably, in all embodiments, the base and the perimetrical edge define a sucker shape.

Generally the first portion preferably comprises a thread for screwing the gripping element to a manipulator. The thread could be inside or outside the first portion, depending on cases. This feature is especially useful. A shape coupling would exhibit weakness when the gripping element is subjected to continuous thermal gradients leading the element itself to expand and contract, causing the disengagement. On the contrary the thread is always effective, also when the gripping element is subjected to continuous thermal gradients. Furthermore, by arranging one or more standard threads the gripping element can be anchored to existing manipulators or corresponding jointing elements, without modifications.

Preferably the first portion and the second portion are made in one item. Alternatively the two portions are defined by separate elements that can be coupled one to another, for example removably.

Preferably at least the second portion, and possibly the first portion too, are made of PTFE, or a ceramic material, resisting to high temperatures, in particular higher than 200° C. and preferably of about 400° C. For example, the gripping element can be obtained by the removal machining of material starting from a PTFE or ceramic block. Alternatively the gripping element can be obtained starting from a metal core on which a ceramic layer could be fixed by means of the Physical Vapor Deposition PVD.

The operating of the gripping element according to the present invention can be described as follows.

Once it has been assembled on a manipulator, and the intake duct is connected to an appropriate air intake line, the perimetrical edge of the gripping element is brought in abutment against a surface of the item to be manipulated. At this point the pneumatic constraint is made by drawing the air contained in the volume defined among the base, the perimetrical edge and the surface of the item to be manipulated; at the same time the elastic deformation of the second portion of the gripping element occurs, moving the base in abutment against the item surface, on the same lying plane of the perimetrical edge. In this configuration the manipulator could displace the item anchored to the gripping element. The release is obtained by interrupting the air intake.

In a preferred embodiment, the first and the second portion of the gripping element are elements distinct one from another and operatively coupled by means of an intermediate connecting element, in particular an elastic element for example made of rubber or other resilient material.

The connecting element operates as a swivel or ball joint between the first and the second portion, a gap being present between them.

The swivel joint allows the second portion, which comes into contact with the item, to angularly orient with respect to the first portion connected to the handling device.

Therefore, the second portion is able to arrange on the item so that to abut against the surface of the item itself along a direction substantially perpendicular to its surface; the step of gripping the item is more effective and assured, in particular if the item is moving or subjected to vibrations or oscillations.

In other words, by the resilient connecting element, the base of the second portion is able to be oriented so that it could rest always coplanarly on the item surface thereby assuring an effective drawing step; this allows the considerable reduction of the risks of partial and not stable adhesion thereof.

Preferably, the connecting element is a resilient bushing having a substantially barrel shape. The bushing has a minimum diameter at the ending edges opposite to another, and a maximum diameter at its central portion. The ending edges of the bushing are assembled in hooking seats respectively obtained at the end of the first and the second portion. The bushing keeps the first and the second portion substantially separate one from another; an intermediate chamber, fluidically connected to the intake ducts obtained on the first and the second portion, is defined between the portions.

### BRIEF DESCRIPTION OF THE DRAWINGS

Further characteristics and advantages of the present invention will be more evident from a review of the following specification of a preferred, but not exclusive, embodiment, shown for illustration purposes only and without limitation, with the aid of the attached drawings, in which:

FIGS. 1a and 1b are front and rear perspective views, respectively, of a first embodiment of the gripping element according to the present invention;

FIG. 2a is a longitudinal section view of the gripping element shown in FIG. 1, in a first configuration;

FIG. 2b is a longitudinal section view of the gripping element shown in FIG. 1, in a second configuration;

FIG. 3 is an exploded view of a second embodiment of the gripping element according to the present invention;

FIG. 4 is a longitudinal section view of the gripping element shown in FIG. 3;

FIG. 5 is an exploded view of a third embodiment of the gripping element according to the present invention;

FIG. 6 is a longitudinal section view of the gripping element shown in FIG. 5;

FIGS. 7 and 7a show a perspective view and a longitudinal section view, respectively, of an alternative embodiment of the gripping element, according to the invention;

FIGS. 8 and 8a show a perspective view and a longitudinal section view, respectively, of the gripping element of FIGS. 7 and 7a.

### DETAILED DESCRIPTION OF THE PREFERRED EMBODIMENTS

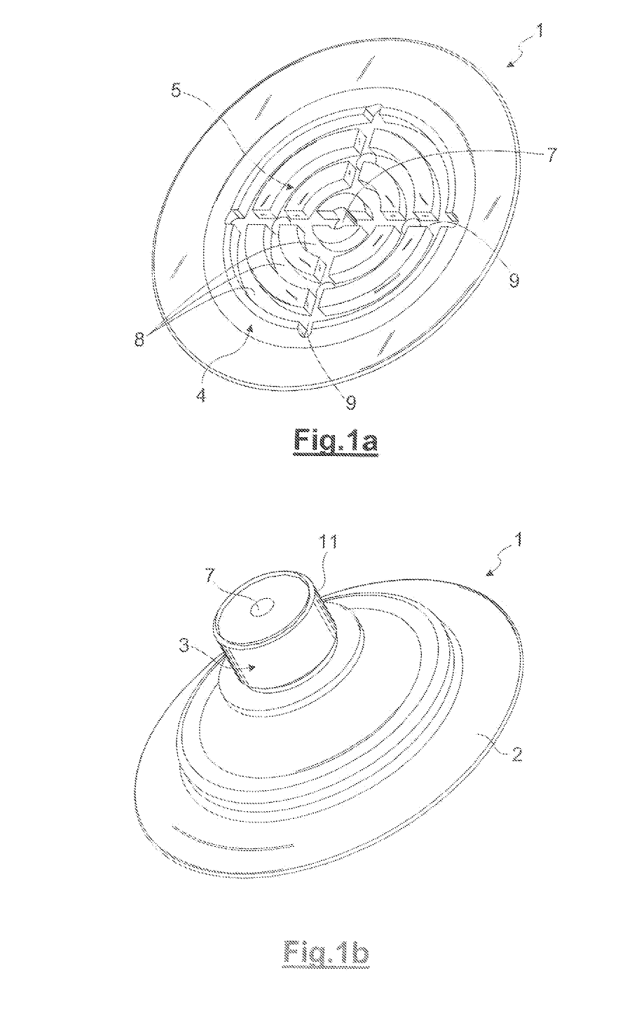

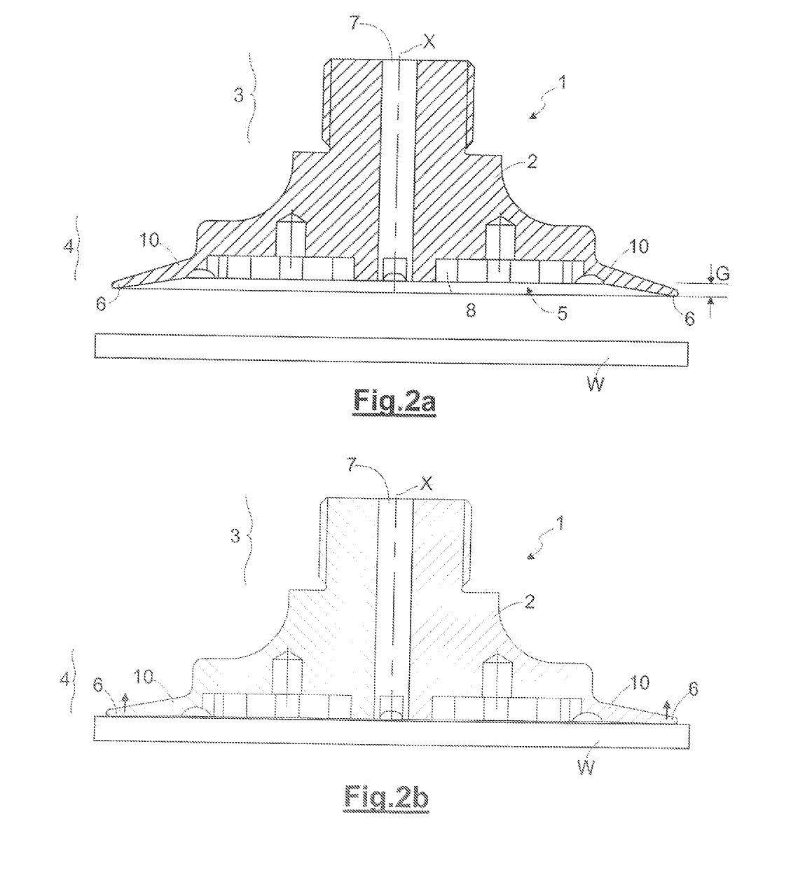

FIGS. 1a-2b show a preferred embodiment of a gripping element 1 according to the present invention. The body 2 of the gripping element 1 is a single item made of PTFE obtained from solid, with turning and eventually, milling techniques of details.

The Applicant noticed that PTFE is a certainly rigid material if compared to the silicone normally used for manufacturing the suckers of industrial manipulators, and however it is provided with a minimum of elasticity allowing it to have the afore described advantages.

For convenience the gripping element 1 has the shape of a sucker with circular section although, strictly speaking, it is not a sucker.

The body 2 comprises a first portion 3, on which means engaging with a manipulator are provided, and a second portion 4, intended to engage the item W to be manipulated, for example a laminate of carbon fiber fabrics impregnated in nylon and heated to about 400° C. to be inserted in a forming mold.

In particular a thread 11 is obtained on the first portion 3, allowing the gripping element 1 to be screwed on manipulators.

The second portion 4 comprises a base 5, shaped as a plate or a substantially flat disc, surrounded by a perimetrical edge 6 contained too in a single lying plane. The base 5 is intended to move into abutment against the item W when the same is anchored to the gripping element 1.

An intake duct 7 extends in the body 2 of the gripping element and opens in the base 5. When the gripping element 1 is connected to a manipulator and the duct 7 is connected to an appropriate line, the air in the volume under the base 5 can be drawn to create the depression necessary to keep the item W anchored to the gripping element 1.

In the embodiment shown in FIGS. 1a-2b, the intake duct 7 opens in the center of the base 5. The base 5 has a plurality of circular and concentric grooves 8 fluidically connected to transversal grooves 9 in their turn connected to the intake duct 7. In practice the grooves 8 and 9 define a labyrinth whose function is to aid the air intake also from peripheral areas of the base 5.

The perimetrical edge 6 surrounding the base 5 belongs to a portion 10 extending substantially cantileverly from the base 5, radially with respect to the longitudinal axis X of the duct 7. The portion 10 closes the base 5 like a bell.

In FIG. 2a the gripping element 1 is shown in a first non-deformed configuration, that is gripping the item W. In this configuration a center-to-center or gap G is present between the lying plane of the base 5 and the lying plane of the perimetrical edge 6; in other words the two lying planes are parallel and separated, and the lying plane of the base 5 is over the lying plane of the perimetrical edge 6.

In the shown embodiment the center-to-center G is equal to about 1 mm.

As afore explained, PTFE and ceramic are substantially rigid material, but for the purposes of the present invention their little elasticity, with the described geometry, are sufficient to cause the base 5 to move in abutment against the item W.

FIG. 2b shows the gripping element 1 constrained to the item W because of the depression created by drawing the air of the volume comprised among the portion 10, the base 5 and the item W. The second portion 4 of the gripping element 1 is elastically deformed: the cantilevered portion 10 is partially bent in a direction opposite to the item W and the base 5 rests on the same item W, so that the lying plane of the base 5 coincides with the lying plane of the perimetrical edge 6 and the upper surface of the item W, therefore the latter will not be able to deform like a dome because of its own weakness and the created depression.

Then, advantageously, the item W can be displaced with no drawbacks. It will not deform and the gripping element 1 is able to resist indefinitely to high temperature of the item W. Therefore the manipulation of the item W by the manipulator can have the desired duration.

Advantageously PTFE and ceramic materials do not leave any residues on manipulated items W. This allows to avoid the described problems relating to painting and it allows to avoid the smearing of the gripping element itself.

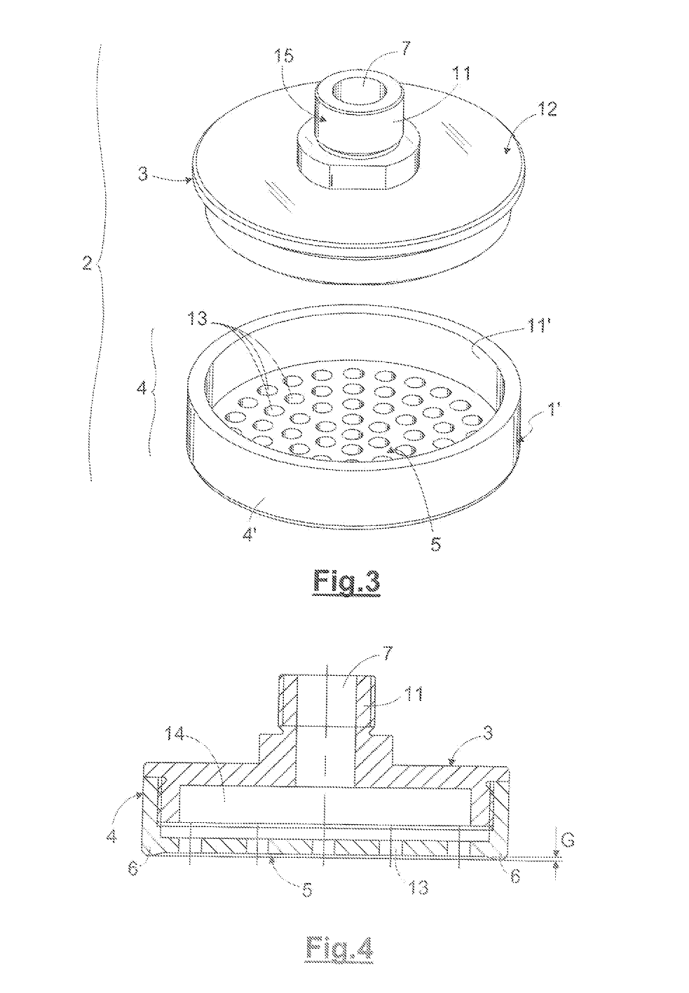

FIG. 3 shows a second embodiment of a gripping element 1′ according to the present invention, also made of PTFE or a ceramic material. The first portion 3 and the second portion 4 are defined by distinct items, screwable one to the other. In particular the first portion 3 is shaped like an adapter screwable to the manipulator by means of the thread 11 obtained on the stem 15. The stem is holed at the intake duct 7. The second portion 4 is shaped like a circular plate provided with a base 5 in which several through holes 13 are obtained. A thread 11′ for the screwing to the adapter 3 is obtained internally on the side wall 4′ of the portion 4.

FIG. 4 is a longitudinal section of the gripping element 1′. It can be noticed that a chamber 14 is defined between the two portions 3 and 4, fluidically connected to the intake duct 7 and the holes 13 which open through the base 5. In this embodiment the perimetrical edge 6 is composed of a prominence or a localized thickening of the base 5. The gap G between the lying planes of the base and the perimetrical edge is lower than 1 mm.

When the gripping element 1 is moved onto the item W and activated by depression, that is by drawing air from the holes 13 through the duct 7, the second portion 4 is deformed elastically, for example the base 5 tends to bow outwards or the perimetrical 6 to tilt inwards, so that the base 5 and the perimetrical edge 6 are substantially coplanar on the surface of the item W in order to avoid the deformations thereof.

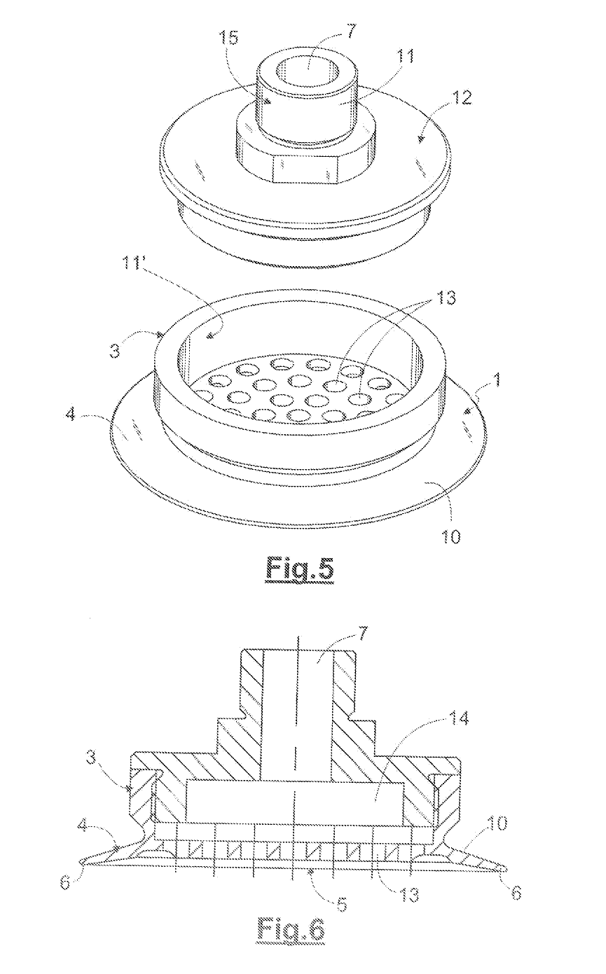

FIGS. 5 and 6 show a third embodiment, respectively in an exploded view and a longitudinal view, that can be considered as a middle way between the first and the second embodiment. The perimetrical edge 6 is obtained on a portion 10 extending cantileverly from the base 5, radially outwards with respect to the axis of the duct 7. As in the embodiment of FIGS. 1a-2b, the portion 10 is at least in part elastic so that to be subjected to little bending and to facilitate the approaching movement leading the base 5 in abutment onto the item W.

The center-to-center between the lying plane of the perimetrical edge 6 and the lying plane of the base 5 is comprised between 0.5 mm and 1 mm.

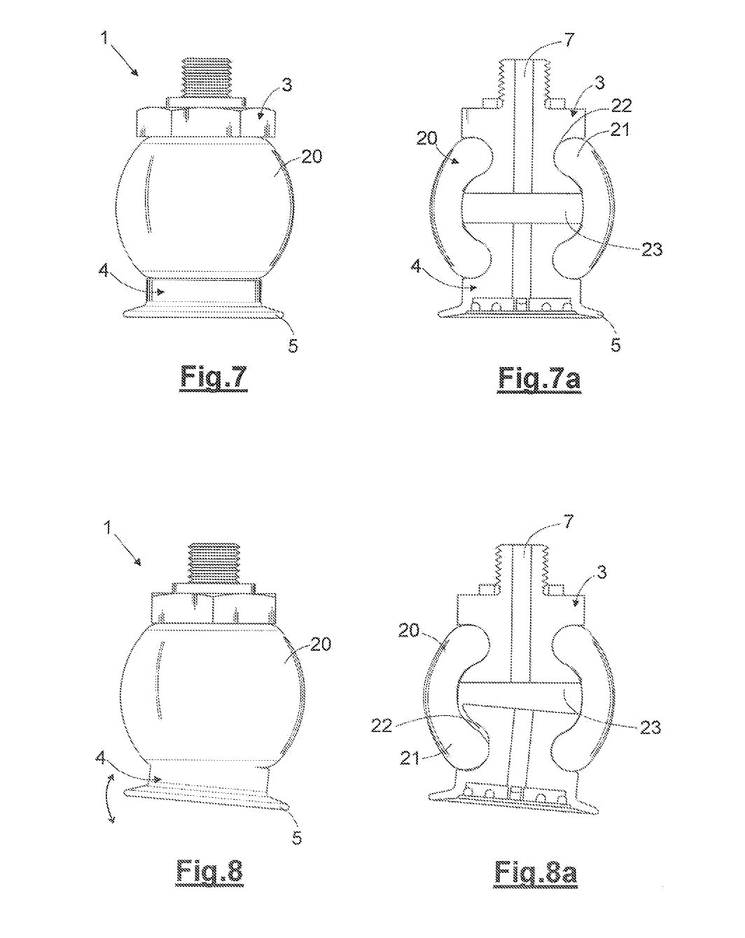

In FIGS. 7, 7a and 8, 8a an additional alternative embodiment of the gripping element 1 is shown, in which the first 3 and the second 4 portion are elements distinct and independent one from another. The latter are operatively coupled by means of a connecting element 20, in particular an elastic element made of rubber, that allows realization of a swivel or ball joint between the two portions 3 and 4. In this way, the adhesion step of the gripping element 1 on the item W, especially if the latter is moving or subjected to vibrations, is more effective and assured.

In particular, the swivel joint 20 allows the second portions 4, and in particular the base 5 thereof, to orient relatively to the item W (FIGS. 8 and 8a). If the latter is tilted or subjected to jerks or oscillations caused, for example, by its handling on a production line, the swivel joint 20 always allows to orient the base 5 up the latter rests coplanarly on the surface of the item W. This fact allows the risks of a partial and not stable adhesion of the gripping element 1 on the item W to be considerably reduced.

Constructively, the elastic element 20 is an annular bushing with a substantially rounded or “barrel-like” shape. The curvilinear walls of the bushing 20 has a minimum diameter at the ending edges 21 opposite one to another, and a maximum diameter at a central portion thereof.

The ending edges 21 are assembled on hooking seats 22, better shown in FIG. 8A, respectively obtained on the first 3 and the second 4 portion; the ending edges 21 fluid-tightly embrace the hooking seats 22.

More particularly, the bushing 20 is shaped to have a determined structural bearing capacity, given by the rounded section and the material, allowing the first 3 and the second 4 portion to be kept at a distance one from another, so as to define an intermediate gap or chamber 23 therebetween. The chamber 23 is fluidically connected to the intake duct 7 obtained on both the two portions 3, 4, allowing the aforementioned drawing step. The fluid-tight feature of the chamber 23 is assured by the bushing 20 itself that tightly adheres at its ends to the two portions 3 and 4. The distance between the portions 3, 4 is sufficient for allowing the relative movements of portions one with respect to another. In particular, the second portion 4 is able to oscillate with respect to the first portion 3 of an angle between 1° and 40°, particularly between 1° and 30°.

1. A gripping element (1) having a body (2) comprising:
a first portion (3) coupling with a manipulator and
a second portion (4), at least in part elastically deformable, intended to interact directly with the item (W) to be manipulated, wherein said second portion (4) comprises in its turn a substantially flat base (5) and a perimetrical edge (6), the latter extending around said base (5), and
at least one duct (7) for the air intake extending in the body (2) of the gripping element (1) and opening at the base (5),
wherein the perimetrical edge (6) and the base (5) lie on respective lying plane, and
wherein, in a first non-deformed configuration of said second portion (4), the lying plane of the base (5) is above and parallel to the lying plane of the perimetrical edge (6), and
wherein, in a second deformed configuration of said second portion (4), the lying planes of the perimetrical edge (6) and base (5) are coincident.

2. The gripping element (1) according to claim 1, wherein the non-deformed configuration corresponds to the gripping element (1) at rest and the deformed configuration corresponds to the gripping element (1) in use, with the perimetrical edge (6) and the base (5) both abutting against a surface of the item (W) to be manipulated and the air at the base (5) is drawn to create a depression constraining the item (W) to the gripping element (1).

3. The gripping element (1) according to claim 1, further comprising:
a) a single intake duct (7) opens into the base (5) centrally, and a plurality of substantially circular grooves (8), fluidically connected one to the other by least one transversal groove (9), are obtained in the base (5) to convey towards the intake duct (7) the air contained in the volume closed between the base (5), the perimetrical edge (6) and the surface of the item (W) to be manipulated on which the gripping element (1) abuts; -or—
b) a chamber (14), fluidically connected to the intake duct (7), is defined in the body (2) of the gripping element (1) and several through holes (13) are obtained in the base (5) in order to convey towards the chamber (14) the air contained in the volume defined between the base (5), the perimetrical edge (6) and the surface of the item (W) to be manipulated on which the gripping element (1) abuts.

4. The gripping element (1) according to claim 1, wherein the perimetrical edge (6) is defined by a prominence of said base (5) or belongs to a portion (10) extending cantileverly from said base (5).

5. The gripping element (1) according to claim 4, wherein said portion (10) extending cantileverly is at least partially flexible to facilitate the deformation that moves the base (5) into abutment against the item (W) to be manipulated when the air is drawn through the intake duct (7).

6. The gripping element (1) according to claim 1, wherein the base (5) and the perimetrical edge (6) define a sucker-like shape.

7. The gripping element (1) according to claim 1, wherein the first portion (3) comprises a thread (11) for screwing the gripping element (1) to a manipulator.

8. The gripping element (1) according to claim 1, wherein the first portion (3) and the second portion (4) are made in one item or are made of distinct and connectible elements.

9. The gripping element (1) according to claim 1, wherein at least the second portion (4), and the first portion (3), are made of PTFE, or in a ceramic material, resisting against high temperatures.

10. The gripping element (1) according to claim 1, wherein at least the second portion (4), and the first portion (3), are made in an anti-adherent material, which do not leave residues on manipulated items (W) and, in turn, do not smear when interacting with manipulated items (W).

11. The gripping element (1) according to claim 1, wherein the first (3) and the second (4) portion are elements mutually distinct and operatively coupled by a resilient connecting element (20) that generally operates as a swivel or ball joint between said first (3) and second (4) portion.

12. Gripping element (1) according to claim 11, wherein said connecting element is a bushing (20) having a substantially rounded or barrel-like shape, said bushing (20) comprises ending edges (21) opposed one to another and assembled in hooking seats (22) obtained on the first (3) and the second (4) portion, respectively, wherein the bushing (20) keeps the first (3) and the second (4) portion substantially separate one from another between which a chamber (23), fluidically connected to the intake ducts (7) of the first (3) and the second (4) portion, is defined.

13. A method for handling an item whose temperature is higher than 200° C., by means of an industrial manipulator, comprises the steps of:
arranging on the manipulator a gripping element (1) according to claim 1;
connecting the intake duct (7), or ducts, of the gripping element (1) to an intake line of the manipulator;
moving the perimetrical edge (6) of the gripping element (1) into abutment against a surface of the item (W) to be manipulated;
drawing the air contained in the volume defined between the base (5), the perimetrical edge (6) and the surface of the item (W) to be manipulated, causing the elastic deformation of the second portion (4) of the gripping element (1) that moves the base (5) into abutment against the surface of the item (W), on the same lying plane of the perimetrical edge (6);
displacing the item (W) and releasing it by interrupting the air drawing.
